(19) United States
(12) Patent Application Publication
(10) Pub. No.: US 2026/0028434 A1
(43) Pub. Date: Jan. 29, 2026

(54) REMOVAL OF ODORANTS FROM POLYOLEFIN PARTICLES

(71) Applicant: BOREALIS AG, Vienna (AT)

(72) Inventors: Peter Denifl, Linz (AT); Kilian Piettre, Linz (AT); Andreas Fuchs, Linz (AT); Theresa Kaltenbrunner, Linz (AT); Cheng Pan, Linz (AT)

(21) Appl. No.: 18/848,663

(22) PCT Filed: Mar. 24, 2023
(86) PCT No.: PCT/EP2023/057641

§ 371 Date: Sep. 19, 2024

(30) Foreign Application Priority Data
Mar. 25, 2022 (EP) 22 164 329.9

(51) Int. Cl. C08F 6/28; B29B 17/00; B29B 17/04; B29K 23/00; B29K 105/26; C08J 11/08

(52) U.S. Cl. CPC C08F 6/28; C08J 11/08; B29B 2017/0015; B29B 17/04; B29K 2023/00; B29K 2105/26; C08J 2323/00

(57) ABSTRACT

The present invention relates to a process for reducing contaminants comprising volatile organic compounds and semi-volatile organic compounds from polyolefin-containing particles by contacting the particles with a washing liquid, which comprises a mixture of polyethylene glycol and water and the use of said washing liquid for reducing said contaminants from polyolefin-containing particles.

The present invention relates to a process for reducing contaminants comprising volatile organic compounds and semi-volatile organic compounds from polyolefin-containing particles by contacting the particles with a washing liquid, which comprises a mixture of polyethylene glycol and water and the use of said washing liquid for reducing said contaminants from polyolefin-containing particles.

### TECHNICAL BACKGROUND

During the last decade, concern about plastics and the environmental sustainability of their use in current quantities has grown. This has led to new legislation on disposal, collection and recycling of polyolefins. There have additionally been efforts in a number of countries to increase the percentage of plastic materials being recycled instead of being sent to landfill.

In Europe, plastic waste accounts for approximately 27 million tons of waste a year; of this amount in 2016, 7.4 million tons were disposed of in landfill, 11.27 million tons were burnt (in order to produce energy) and around 8.5 million tons were recycled. Polypropylene based materials are a particular problem as these materials are extensively used in packaging. Taking into account the huge amount of waste collected compared to the amount of waste recycled back into the stream (amounting to only about 30%), there is still a great potential for intelligent reuse of plastic waste streams and for mechanical recycling of plastic wastes.

Taking the automobile industry as an example. In Europe the end of life (ELV) directive from the EU states, that 85%/95% of materials from vehicles should be recyclable or recoverable. The present rate of recycling of automobile components is significantly below this target. On average vehicles consist of 9 wt.-% plastics, out of this 9 wt.-% only 3 wt.-% is currently recycled. Therefore, there is still a need to be met if targets for recycling plastics in the automobile industry are to be achieved. This invention particularly focuses on mechanically recycled waste streams as opposed to “energetic recycling” where polyolefins are burnt and used for energy. However, due to cost reasons, poor mechanical properties and inferior processing properties waste streams containing cross-linked polyolefins are often used for energy recovery (e.g. incineration in a district heating plant or for heat generation in the cement industry) and are less often recycled into new products.

One major trend in the field of polyolefins is the use of recycled materials that are derived from a wide variety of sources. Durable goods streams such as those derived from waste electrical equipment (WEE) or end-of-life vehicles (ELV) contain a wide variety of plastics. These materials can be processed to recover acrylonitrile-butadiene-styrene (ABS), high impact polystyrene (HIPS), polypropylene (PP) and polyethylene (PE) plastics. Separation can be carried out using density separation in water and then further separation based on fluorescence, near infrared absorption or raman fluorescence. However, it is commonly quite difficult to obtain either pure recycled polypropylene or pure recycled polyethylene. Generally, recycled quantities of polypropylene on the market are mixtures of both polypropylene (PP) and polyethylene (PE); this is especially true for post-consumer waste streams. Commercial recyclates from post-consumer waste sources have been found generally to contain mixtures of PP and PE, the minor component reaching up to <50 wt.-%.

The better the quality, i.e. the higher the purity, of the recycled polyolefin the more expensive the material is. Moreover, recycled polyolefin materials are often cross-contaminated with non-polyolefin materials, such as polyethylene terephthalate, polyamide, polystyrene or non-polymeric substances like wood, paper, glass or aluminium.

In addition, recycled polypropylene rich materials normally have properties, which are much worse than those of the virgin materials, unless the amount of recycled polyolefin added to the final compound is extremely low. For example, such materials often have poor performance in odour and taste, limited stiffness, limited impact strength and poor mechanical properties (such as e.g. brittleness) thus, they do not fulfil customer requirements.

The poor mechanical properties can be improved through blending the recycled polyolefin with virgin polymers, or through the use of reinforcing fillers, however this does not address the issue of odour/taste.

The established method for removing volatile organic compounds from both virgin polymers and from recycled polymers involves aeration of the polymers. This may be achieved, inter alia, through the use of air, inert gases or steam.

Variants on this process have been known for many years, and are described, inter alia, in EP 0 004 601 A1, EP 0 859 809 A1, EP 0 964 877 A1, EP 1 542 777 A2, and EP 3 647 328 A1.

Whilst these methods can be very efficient at removing a broad range of volatile compounds, they can be energy intensive, which can be counterproductive when aiming for a recycling process that is as environmentally friendly as possible.

As such, there remains a need for further methods of reducing odorous, volatile compounds from polyolefin compositions.

The present invention is based upon the finding that treatment of polyolefin-containing particles with a washing liquid, which comprises a mixture of polyethylene glycol and water and has a pH in the range from 7.0 to 14.0 is effective for the removal of both hydrophilic volatile organic compounds and hydrophobic volatile organic compounds.

### SUMMARY OF THE INVENTION

The present invention relates to a process for reducing contaminants from polyolefin-containing particles, comprising the steps of:
a) providing particles comprising polyolefin and contaminants comprising volatile organic compounds and semi-volatile organic compounds;
b) contacting the particles with a washing liquid, which comprises a mixture of polyethylene glycol and water and has a pH in the range from 7.0 to 14.0;
c) removing the washing liquid from the particles,
   thereby obtaining particles with a reduced amount of contaminants,
   whereby volatile organic compounds are defined as organic compounds having an initial boiling point (b.p.) of less than or equal to 250° C. when measured at a standard atmospheric pressure of 101.3 kPa and semi-volatile organic compounds are defined as organic compounds having an initial boiling point (b.p.) of from 250 to 380° C. when measured at a standard atmospheric pressure of 101.3 kPa.

Additionally, the present invention relates to the use of a washing liquid, which comprises a mixture of polyethylene glycol and water and has a pH in the range from 7.0 to 14.0, for removing contaminants comprising volatile organic compounds and semi-volatile organic compounds from particles comprising polyolefin and contaminants comprising volatile organic compounds and semi-volatile organic compounds,

whereby volatile organic compounds are defined as organic compounds having an initial boiling point (b.p.) of less than or equal to 250° C. when measured at a standard atmospheric pressure of 101.3 kPa and semi-volatile organic compounds are defined as organic compounds having an initial boiling point (b.p.) of from 250 to 380° C. when measured at a standard atmospheric pressure of 101.3 kPa.

### Definitions

In the context of the present invention, the term “volatile organic compound” refers to any organic compound having an initial boiling point of less than or equal to 250° C., which is the definition set out by the European Union in the VOC Solvents Emissions Directive 1999/13/EC.

Analogous to the definition of the term “volatile organic compound” the term “semi-volatile organic compounds” refers to any organic compound having an initial boiling point of from 250 to 380° C.

The person skilled in the art would be aware that pH values of greater than 14.0 and lower than 0.0 are theoretically possible; however, they would also be aware that the determination of such pH values is incredibly difficult using conventional pH probes.

As such, in the context of this invention, aqueous solutions having an effective pH of greater than 14.0 are considered to have a pH of 14.0 and aqueous solutions having an effective pH of lower than 0.0 are considered to have a pH of 0.0.

In the context of the present invention, the term “rinse” is used to indicate the addition of a solvent, typically water, which is used to remove foreign material or remaining liquid from the surface of the polyolefin. This can be achieved in very short times, i.e. less than 5 minutes, often less than 1 minute, in contrast to “washing” steps that typically require a longer time, and agitation, to extract volatile organic compounds from the polyolefin.

Post-consumer waste refers to objects having completed at least a first use cycle (or life cycle), i.e. having already served their first purpose; while post-industrial waste refers to manufacturing scrap, which does not normally reach a consumer.

Virgin polyolefin refers to polyolefin powders directly from the polymerization reactor or polyolefin pellets, which are obtained after a single compounding step in which the polyolefin powders directly from the polymerization reactor are compounded usually in the presence of accordant additives into pellets. Virgin polyolefin generally differs from post-consumer waste and post-industrial waste in that it has not been subjected to any processing other than for its production, such as it has not been formed into an article.

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of elements, this is also to be understood to disclose a group, which preferably consists only of these elements.

Where an indefinite or definite article is used when referring to a singular noun, e.g. “a”, “an” or “the”, this includes a plural of that noun unless something else is specifically stated.

### DETAILED DESCRIPTION OF THE INVENTION

### Process

In a first aspect the present invention relates to a process for reducing contaminants from polyolefin-containing particles, comprising the steps of:
a) providing particles comprising polyolefin and contaminants comprising volatile organic compounds and semi-volatile organic compounds;
b) contacting the particles with a washing liquid, which comprises a mixture of polyethylene glycol and water and has a pH in the range from 7.0 to 14.0;
c) removing the washing liquid from the particles,
   thereby obtaining particles with a reduced amount of contaminants,
   whereby volatile organic compounds are defined as organic compounds having an initial boiling point (b.p.) of less than or equal to 250° C. when measured at a standard atmospheric pressure of 101.3 kPa and semi-volatile organic compounds are defined as organic compounds having an initial boiling point (b.p.) of from 250 to 380° C. when measured at a standard atmospheric pressure of 101.3 kPa.

The polyolefin-containing particles comprise polyolefin and contaminants. The contaminants comprise at least volatile organic compounds and semi-volatile organic compounds. Additionally, the contaminants can further comprise dirt, oil, fat, adhesives and other non-wanted components.

These contaminants thereby depend on the origin of the particles.

In recycling streams such as post-consumer waste or post-industrial waste the contaminants often result from the additives, pigments, fillers and other components intentionally added to the polymer compositions before forming the accordant articles as well as from degradation products obtained during forming the accordant articles and later storage and use.

In post-consumer waste the contaminants typically result additionally from contamination during the first use of the polymer, often when the polymer is used as packaging material, especially for food and/or personal care compositions.

Additionally, in post-consumer waste contaminants can originate from cross-contamination during waste disposal or collection. In addition, in post-consumer waste contaminants can originate from incomplete sorting (e.g. non-polyolefin polymers, cardboard, metals) and incomplete removal of labels, glue adhesives and so on. These contaminants can also decompose or catalyze decomposition and result in the formation of volatile organic compounds or semi-volatile organic compounds e.g. during extrusion.

In virgin polyolefin the contaminants typically result from oligomers formed during the polymerization process as by-product, catalyst residues, decomposition products, like oxidation products, of the polymer and the additives which are formed during the extrusion/compounding process for forming e.g. pellets.

The particles preferably comprise polyolefin in an amount of from 75.00 to 99.99 wt %, more preferably from 80.00 to 99.95 wt %, still more preferably from 85.00 to 99.90 wt %, based on the total weight of the particles.

The polyolefin is preferably selected from virgin polyolefin and recycled polyolefin obtained from post-consumer waste and/or post-industrial waste or mixtures thereof.

It is preferred that the polyolefin at least comprises recycled polyolefin obtained from post-consumer waste.

The particles are preferably powder, pellets or flakes.

Flakes are typically obtained by applying a size reduction process to articles or objects like shredding or any other suitable method known to the person skilled in the art. The flakes can have any suitable size, usually determined by the surface area.

In the context of the present invention, the flake surface area is defined as the surface area of one of the faces of a flaked polyolefin. This surface area is approximately half of the total surface area of the flake, which has two such faces in addition to a very small amount of surface area coming from the edges of the flake. Flakes according to the present invention will typically have a flake surface area in the range from 50 to 2500 mm², more preferably in the range from 100 to 1600 mm², most preferably in the range from 150 to 900 mm².

Pellets are typically obtained from melt extrusion processes as known in the art.

Pellets typically have an average diameter of up to 20 mm.

Powders are typically obtained from the polymerization process or from applying a size reduction process to articles or objects like grinding, milling or any other suitable method known to the person skilled in the art.

It is preferred that the process further comprises the step of
a1) shredding polyolefin containing material to obtain particles comprising polyolefin and contaminants selected from volatile organic compounds and semi-volatile organic compounds prior to step a).

This has been found to improve the extraction of the contaminants both as a result of higher effective surface areas and also improved ease of agitation, should agitation be required.

The mixture of polyethylene glycol and water in the washing liquid preferably has a ratio of polyethylene glycol to water in the range of from 25 vol.-%:75 vol.-% to 99 vol.-%:1 vol.-%, more preferably from 35 vol.-%:65 vol.-% to 97 vol.-%:3 vol.-%, still more preferably from 50 vol.-%:50 vol.-% to 95 vol.-%:5 vol.-%.

The polyethylene glycol preferably has a rather low molecular weight, such as an average molecular weight Mn of from 100 to 350 g/mol, preferably from 150 to 300 g/mol, more preferably from 175 to 250 g/mol.

Mn is usually disclosed by the suppliers in the technical documentation of the commercial products. Otherwise the Mn can be measured by GPC as known in the art.

In another embodiment polyethylene glycol with a higher molecular weight can be used. In said embodiment the polyethylene glycol preferably is a hyper branched and/or dendronised polyethylene glycol. Such hyper branched and/or dendronised polyethylene glycol usually has a molecular weight above 1000 g/mol.

The washing liquid in one embodiment consists of the mixture of polyethylene glycol and water. This means that the washing liquid does not comprise any other components apart from polyethylene glycol and water. In said embodiment the washing liquid has a pH of 7.0.

In another embodiment the washing liquid further comprises a base, preferably selected from the group consisting of calcium hydroxide, potassium hydroxide, magnesium hydroxide, lithium hydroxide, sodium bicarbonate, sodium hydroxide and mixtures thereof, most preferably sodium hydroxide.

In said embodiment the base is preferably present in the washing liquid in an amount of from 0.1 to 5.0 wt %, more preferably from 0.2 to 3.5 wt %, still more preferably from 0.3 to 2.5 wt %, based on the total weight of the washing liquid.

In said embodiment the washing liquid has a pH of more than 7.0 to 14.0, depending on the amount of base in the washing liquid.

It is preferred that the particles are contacted with the washing liquid in step b) at a temperature of from 20 to 100° C., preferably from 60 to 100° C., more preferably from 70 to 100° C.

It has been found that while conducting step b) at lower temperature such as room temperature is already effective for removing contaminants the effectivity can be further increased at elevated temperatures for some groups of contaminants.

Step b) is typically carried out without artificially elevating or decreasing the pressure. As such, it is preferred that step (b) is carried out at a pressure in the range from 0.5 to 2.0 atm, more preferably in the range from 0.8 to 1.5 atm, most preferably at 1.0 atm.

The particles are preferably contacted with the washing liquid in step b) for a time span of from 5 to 240 min, more preferably from 5 to 150 min.

In industrial washing processes the time span usually is in the range of from 5 to 20 min.

It is further preferred that the particles and the washing liquid during step b) are subjected to agitation through mechanical mixing, ultrasonic treatment, mechanical grinding or pump around loop. This agitation helps to expose the surface of the particles to washing liquid, avoiding that a high concentration of extracted contaminants at the interface would hinder further extraction.

Preferably, the particles and the washing liquid are present in step b) in a weight ratio in the range from 5:95 to 67:33, most preferably in the range from 5:95 to 45:55.

Step c) involves the removal of washing liquid from the particles. Whilst this process is relatively simple to achieve through decanting and/or filtering the mixture, traces of the washing liquid can remain on the surface of the particles. These traces of washing liquid may contain solubilised contaminants, and it is therefore advantageous to remove all traces of the washing liquid.

This may be achieved through the use of rinsing steps, whereby any foreign material and/or aqueous solutions are rinsed from the surface of the particles.

As such, it is preferred that the process comprises an additional step (d) of rinsing residue of the washing liquid and/or any other foreign material and/or degradation products thereof from the particles with an aqueous solution having a pH of from 7.0 to 14.0, which is carried out after step c).

The aqueous solution can consist of water. In this embodiment the aqueous solution has a pH of 7.0.

In another embodiment the aqueous solution is a caustic aqueous solution comprising base, preferably selected from the group consisting of calcium hydroxide, potassium hydroxide, magnesium hydroxide, lithium hydroxide, sodium bicarbonate, sodium hydroxide and mixtures thereof, most preferably sodium hydroxide.

In said embodiment the base is preferably present in the aqueous solution in an amount of from 0.5 to 10.0 wt %, more preferably from 1.0 to 5.0 wt %, based on the total weight of the aqueous solution.

In said embodiment the aqueous solution has a pH of more than 7.0 to 14.0, depending on the amount of base in the aqueous solution.

The optional treatment of the particles with the aqueous solution in step d) is a rinsing step, as opposed to the washing step b) as defined herein, and consequently typically lasts less than 5 minutes, like not more than 3 minutes.

In addition to, or alternatively to, the rinsing step (d), it is preferred that the process comprises an additional step (e) of drying the particles, which is carried out after step (c) or, if step (d) is present, after step (d). This drying step removes any residual washing liquid or aqueous solution that may be present on the surface of the particles.

The process as described above and below results in the at least partial removal of contaminants, especially volatile organic compounds and semi-volatile organic compounds from the particles.

It is particularly preferred that the content of at least one volatile organic compound or semi-volatile organic compound in the particles obtained as a product of the process, as measured by static headspace-gas chromatography/mass spectrometry (HS-GC/MS), has been reduced by at least 75% relative to the content measured before the process.

Whilst there are a large number of volatile organic compounds and semi-volatile organic compounds that may be present in polyolefin containing particles, which often differ from batch to batch, there are a number of volatile organic compounds and semi-volatile organic compounds that are particularly useful for determining the effect of the process of the present invention due to ease of detection and ubiquity in polyolefin containing particles, especially when considering particles comprising post-consumer waste. Consequently, it is preferred that the individual contents of contaminants are assessed through the detection of limonene, acetic acid, acetaldehyde and benzaldehyde.

It is preferred that the particles obtained as a product of the process as described herein have a limonene content, as measured by HS-GC/MS, of less than 70%, preferably less than 50% of the value measured before the process.

Further, the particles obtained as a product of the process as described herein have an acetic acid content, as measured by HS-GC/MS, of less than 15%, preferably less than 10% of the value measured before the process.

Still further, the particles obtained as a product of the process as described herein have an acetaldehyde content, as measured by HS-GC/MS, of less than 25%, preferably less than 20% of the value measured before the process.

Additionally, the particles obtained as a product of the process as described herein have a benzaldehyde content, as measured by HS-GC/MS, of less than 25%, preferably less than 20% of the value measured before the process.

The lower limit for the content of each of the contaminants described above, as measured by HS-GC/MS, is preferably 0% of the value measured before the process.

The process of the present invention as described herein has surprisingly been found to be especially effective for removing potentially hazardous contaminants, such as benzene, toluene, ethyl-benzene, o-xylene and styrene. Said hazardous contaminants have turned out to be insufficiently removable from polyolefin containing particles when using known washing techniques. The content of some of these contaminates, especially benzene, even seems to increase after washing, resulting in higher contents after washing such as double or triple contents. Therefore, an effective method for reducing such contaminants is especially needed.

It is preferred that the particles obtained as a product of the process as described herein have a benzene content, as measured by HS-GC/MS, of less than 150%, preferably less than 50% of the value measured before the process.

Further, the particles obtained as a product of the process as described herein have a toluene content, as measured by HS-GC/MS, of less than 75%, preferably less than 70% of the value measured before the process.

Still further, the particles obtained as a product of the process as described herein have an ethyl benzene content, as measured by HS-GC/MS, of less than 70%, preferably less than 50% of the value measured before the process.

Additionally, the particles obtained as a product of the process as described herein have an o-xylene content, as measured by HS-GC/MS, of less than 70%, preferably less than 35% of the value measured before the process.

Further, the particles obtained as a product of the process as described herein have a styrene content, as measured by HS-GC/MS, of less than 70%, preferably less than 60% of the value measured before the process.

The lower limit for the content of each of the contaminants described above, as measured by HS-GC/MS, is preferably 0% of the value measured before the process.

### Use

In a further aspect the present invention relates to the use of a washing liquid, which comprises a mixture of polyethylene glycol and water and has a pH in the range from 7.0 to 14.0, for removing contaminants comprising volatile organic compounds and semi-volatile organic compounds from particles comprising polyolefin and contaminants comprising volatile organic compounds and semi-volatile organic compounds,

whereby volatile organic compounds are defined as organic compounds having an initial boiling point (b.p.) of less than or equal to 250° C. when measured at a standard atmospheric pressure of 101.3 kPa and semi-volatile organic compounds are defined as organic compounds having an initial boiling point (b.p.) of from 250 to 380° C. when measured at a standard atmospheric pressure of 101.3 kPa.

It is preferred that in the use of the present invention the washing liquid is applied to the particles in accordance with the process of the present invention as described herein.

Preferably all aspects of the washing liquid, the particles and the process of the invention as described above or below also apply to the use of the present invention.

The present invention is further characterized by the following non-limiting examples.

### EXAMPLES

### 1. Definitions/Determination Methods

### Determination of Volatile Organic Compounds Via HS-GC/MS

The parameters of the applied static headspace-gas chromatography/mass spectrometry (HS-GC/MS) method are described here.

For the measurement of a benzene standard 5 μl of a standard solution containing 100 μg/ml benzene in methanol were injected into a 20 ml HS vial and tightly closed with a PTFE cap. Each HS-GC/MS test sequence of sample measurements included the analysis of such a benzene standard. The benzene signal of the corresponding sequence was used for the calculation of the relative normalised area as described further below.

The samples were also analysed by HS-GC/MS in order to determine potential odorant and hazardous marker substances. Therefore, a sample aliquot of 2.000±0.100 g was weighed in a 20 ml HS vial and tightly sealed with a PTFE cap.

For each washing experiment a double (or triple) determination of the respective sample was performed.

Applied headspace parameters for the analyses of standards and samples differed in the vial equilibration time and the HS oven temperature. Apart from that, method parameters were kept the same for standard and sample runs. The mass spectrometer was operated in scan mode and a total ion chromatogram (TIC) was recorded for each analysis. The detected substances were tentatively identified by the aid of deconvolution and comparison to a mass spectral library. When applicable, identification was done by a direct comparison to a standard. More detailed information on method parameters and data evaluation software is given below:

HS parameter (Agilent G1888 Headspace Sampler)

| | |
|---|---|
| Vial equilibration time: | 5 min (benzene standard), 120 min (sample) |
| Oven temperature: | 200° C. (benzene standard), 100° C. (sample) |
| Loop temperature: | 205° C. |
| Transfer line | 210° C. |
| temperature: | |
| Low shaking | |

GC parameter (Agilent 7890A GC System)

| | |
|---|---|
| Column: | ZB-WAX 7HG-G007-22 (30 m × 250 μm x 1 μm) |
| Carrier gas: | Helium 5.0 |
| Flow: | 2 ml/min |
| Split: | 10:1 |
| GC oven program: | 35° C. for 0.1 min |
| | 10° C./min until 250° C. |
| | 250° C. for 1 min |

MS parameter (Agilent 5975C inert XL MSD)

| Acquisition mode: | Scan |
|---|---|
| Scan parameters: | |
| Low mass: | 20 |
| High mass: | 200 |
| Threshold: | 10 |

### Software/Data Evaluation

MSD ChemStation E.02.02.1431 (first data set) and F.01.03.2357 (second data set)
MassHunter GC/MS Acquisition B.07.05.2479
AMDIS GC/MS Analysis Version 2.71 (first data set) and Version 2.73 (second data set)
NIST Mass Spectral Library (Version 2011, first data set) and (Version 2017, second data set)
Microsoft Excel 2016

### Data Evaluation

The extracted ion chromatograms (EICs) of the measured benzene standards and samples were created. The peak areas required for the further data evaluation were obtained by integrating the corresponding substance peak of the EIC. Target ions (m/z ratios) of selected marker substances are listed in Table 1.

TABLE 1
Substance specific target ions of selected marker compounds.

| Substance | Target ion of the corresponding EIC (m/z) |
|---|---|
| Acetaldehyde | 44 |
| Benzene¹ | 78 |
| Toluene | 91 |
| Ethylbenzene | 106 |
| o-Xylene | 106 |
| D-Limonene | 136 |
| Styrene | 104 |
| Acetic acid² | 60 |
| Benzaldehyde | 106 |
| Acetophenone | 105 |

¹Relevant for both, standards and samples.
²In the HS-GC/MS analysis the acetic acid peak was not sufficiently separated from the peak corresponding to ethylhexanol in the first data set of examples IE1-IE7 and CE1-CE3. Therefore, the area of the acetic acid peak also includes the ethylhexanol impurity. This minor impurity has not been observed to have a significant influence on the values obtained in the data presented below. In the second data set of examples IE8-IE10 and CE4-CE6, an additional rider peak on top of the acetic acid peak was found in some samples. In such a case, the peak area of the rider peak was subtracted from the total peak area of the acetic acid peak and the rider peak together. A similar integration strategy was also found in VDA 278 (Version 2011, 4.5.3 Evaluation for rider peaks and “oilhills”).

The substance specific target ion peak areas (Area(EIC)_{X}) were normalised by the target ion peak area of benzene (Area(EIC)_{Benzene}) and the sample amount in order to obtain the normalised area (norm. Area_{X}, see equation 1).

$$norm . {Area}_{X} = \frac{{Area ( EIC )}_{X}}{{Area ( EIC )}_{Benzene} * sample amount [ g ]} \qquad Equation 1$$

For each washing experiment the normalised mean area (n̅o̅r̅m̅.̅ A̅r̅e̅a̅_̅{̅X̅}̅) of the two (or three) individual analyses (norm. Area_{X1}, norm. Area_{X2}, and if applicable norm. Area_{X3}) was calculated by using the Excel function AVERAGE (see equation 2).

$$\overline{norm . {Area}_{X}} = AVERAGE ( norm . {Area}_{X 1} , norm . {Area}_{X 2} , norm . {Area}_{X 3} ) \qquad Equation 2$$

To obtain the relative normalised area (rel. norm. Area_{X}), the normalised mean area of the respective substance (n̅o̅r̅m̅.̅ A̅r̅e̅a̅_̅{̅X̅}̅) was divided by the normalised mean area of the reference sample (norm. Area_{R}) as stated in equation 3.

$$rel . norm . {Area}_{X} = \frac{\overline{norm . {Area}_{X}}}{norm . {Area}_{R}} \qquad Equation 3$$

For the data evaluation of the examples as presented below three different cases must be distinguished.
1) The substance specific ion peak was evaluable in all analysis runs of the double (or triple) determination. The relative normalised area was obtained by applying equations 1, 2 and 3 as described above.
2) The substance specific ion peak was not evaluable in one analysis run of the triple determination. Consequently, the normalised mean area (n̅o̅r̅m̅.̅ A̅r̅e̅a̅_̅{̅X̅}̅) is based on the average of the two remaining normalised areas only. In this case, the obtained relative normalised area (rel. norm. Area_{X}) was asterisked (“*”) in the result table.
3) The substance specific ion peak was not evaluable in any of the analysis runs of the double (or triple) determination. Therefore, the calculation of the relative normalised area (rel. norm. Area_{X}) was not applicable (“n.a.”) which was indicated in the result table.

### 2. Experimental Results

In the following experiments, the materials used were as follows:

### Recycled Polyolefin:

The recycled polyolefin employed in the following experiments was obtained from mtm plastics GmbH, Niedergebra, Germany, and is a pre-sorted, unwashed polymer mixture used by mtm plastics GmbH in the preparation of Dipolen S. Consequently the composition of the recycled polyolefin with regard to the content of polyethylene and polypropylene is identical to that of Dipolen S; however the content of small molecule contaminants is likely to be different.

Dipolen S is a recycled polymer mixture comprising polyethylene and polypropylene obtained from mtm plastics GmbH, Niedergebra, Germany and has a polyethylene content of 40 wt.-% determined by DSC analysis. The melting points determined by DSC were 162° C. (PP) and 128° C. (PE).

In the following experiments, the recycled polyolefin was obtained in a flaked form; cryo-milling was then undertaken prior to the below experiments in order to enable the experiments to be carried out on a smaller scale than would be the case for the industrial process.

Two different batches of recycled polyolefin were used as discussed below.

The term “washing efficiency” stated in tables 4, 5, 6 and 7 was defined as the percentage of remaining contaminants (rel. norm. Areas, expressed in %) after the treatment with the respective wash solvent.

### Polyethylene Glycol:

The first polyethylene glycol was PEG 200 having an average molecular weight Mn of 200 g/mol, commercially available from VWR International.

The second polyethylene glycol was PEG 400 having an average molecular weight Mn of 400 g/mol, commercially available from VWR International.

### Experimental Procedure:

### i) pH of Different Washing Liquids (pH Paper)

The pH of washing liquid with different amounts of polyethylene glycol (PEG), water (H₂O) and sodium hydroxide (NaOH) was determined by dipping a pH paper into the washing liquid and immediately comparing the readings to the reference. The pH values of the different washing liquids are listed in Table 2.

TABLE 2
pH of washing liquids

| | | | NaOH conc. | |
|---|---|---|---|---|
| | H₂O | PEG | in solution/ | |
| Washing liquid | (vol-%) | (vol-%) | mixture (wt-%) | pH |
| Aqueous NaOH solution | 100 | 0 | 5 | 14 |
| | 100 | 0 | 0.5 | 10 |
| PEG-H₂O | 10 | 90 | 0.5 | 13-14 |
| | 25 | 75 | 1.25 | 13-14 |
| | 50 | 50 | 2.5 | 13-14 |

Additionally, the pH of washing liquid used in examples IE8-IE10 and CE4-CE6 (see Table 8 and 9) was determined by potentiometric measurement using a Metrohm 867 pH Module with Unitrode, commercially available from Metrohm AG. The pH values of said washing liquids are listed in Table 3.

TABLE 3
pH of washing liquids used in examples IE8-IE10 and CE4-CE6

| | | | NaOH conc. | |
|---|---|---|---|---|
| | H₂O | PEG | in solution/ | |
| Washing liquid | (vol-%) | (vol-%) | mixture (wt-%) | pH |
| pure PEG 200 | 0 | 100 | 0 | 8.8 |
| pure PEG 400 | 0 | 100 | 0 | 8.4 |
| PEG 200-H₂O | 50 | 50 | 0 | 7.2 |
| PEG 400-H₂O | 50 | 50 | 0 | 6.5 |
| PEG 200-H₂O + NaOH | 50 | 50 | 2.5 | 13.4 |
| PEG 400-H₂O + NaOH | 50 | 50 | 2.5 | 13.6 |

### ii) EXAMPLES

In a first set of examples IE1-IE7 and CE1-CE3 a first batch of cryo-milled recycled polyolefin (rPO) has been washed with different washing liquid for evaluating the washing efficiency of pure water and mixtures of water and PEG in different weight amounts with and without addition of NaOH at different washing conditions.

The PEG used in said first set of examples was only PEG 200.

The experimental setup and the results are shown below in a) and b).

### a) Comparison of Washing Efficiency of PEG/Water and Water

### Inventive Example 1 (IE1)

A mixture of 475 ml of polyethylene glycol and 25 ml of water (volume ratio PEG to water of 95/5) was added as the washing liquid to 50 g of cryo-milled rPO and the suspension was allowed to mix by means of an overhead stirrer for 2 hours at room temperature.

The washing liquid was then removed by filtration and the polymer powder was two times rinsed with water. Each of these rinsing steps was done by contacting the polymer powder for 30 seconds with 100 ml of demineralised water, followed by removal of the water by filtration. The polymer powder was then dried in a vacuum oven at 70° C. for 1 hour.

### Inventive Example 2 (IE2)

As inventive example 1, except that the suspension was allowed to mix by means of an overhead stirrer for 2 hours at 75° C.

### Inventive Example 3 (IE3)

100 ml of a mixture of polyethylene glycol and water in a volume ratio of polyethylene glycol to water of 95/5 was added to a 250 ml beaker equipped with a magnetic stir bar and the overhead ultrasound probe (UP400S from Hielscher Ultrasonics GmbH with a 40 mm diameter sonotrode; 400 W, 24 kHz). The ultrasound probe was inserted into the liquid at approximately 75% of the liquid volume height. The magnetic stirrer and the ultrasound device were switched on and after 2 minutes 10 g of the cryo-milled polymer powder were added to the washing liquid, followed by stirring and sonication of the suspension for 1 hour at 75° C.

The wash solvent mixture was then removed by filtration and the polymer powder was two times rinsed with water. Each of these rinsing steps was done by contacting the polymer powder for 30 seconds with 100 ml of demineralised water, followed by removal of the water by filtration. The polymer powder was then dried in a vacuum oven at 70° C. for 1 hour.

### Comparative Example 1 (CE1)

As inventive example 1, except that 500 ml of water was added as washing liquid.

### Comparative Example 2 (CE2)

As inventive example 2, except that 500 ml of water was added as washing liquid.

### Comparative Example 3 (CE3)

As inventive example 3, except that 100 ml of water was added as washing liquid.

TABLE 4
Washing efficiency for a PEG/water wash and reference
water wash - odour relevant substances

| | Acetic | Acetal- | Benzal- | | D- |
|---|---|---|---|---|---|
| Examples | acid | dehyde | dehyde | Styrene | Limonene |
| CE1 (RT) | 5.5% | 11.0% | 20.9% | 80.6% | 79.3% |
| IE1 (RT) | 7.7% | 12.1% | 19.7% | 65.1% | 63.8% |
| CE2 (75° C.) | 29.3% | 7.4% | 16.0% | 56.4% | 49.4% |
| IE2 (75° C.) | 7.0% | 12.9% | 6.8% | 45.4% | 18.6% |
| CE3 (75° C., | 10.4% | 6.5% | 16.1% | 63.6% | 56.6% |
| sonication) | | | | | |
| IE3 (75° C., | 6.3% | 16.5% | 15.8% | 43.3% | 16.3% |
| sonication) | | | | | |

TABLE 5
Washing efficiency for a PEG/water wash and
reference water wash - hazardous substances

| | | | Ethyl- | o- | | Aceto- |
|---|---|---|---|---|---|---|
| Examples | Benzene | Toluene | benzene | Xylene | Styrene | phenone |
| CE1 (RT) | 363.3% | 79.2% | 83.7% | 96.2% | 80.6% | 73.7% |
| IE1 (RT) | 133.6% | 72.4% | 66.0% | 61.8% | 65.1% | 54.9% |
| CE2 (75° C.) | 43.5% | 62.9% | 55.1% | 51.2% | 56.5% | 37.3% |
| IE2 (75° C.) | 35.1% | 59.6% | 34.0% | 20.4% | 45.3% | 23.8% |
| CE3 (75° C., | 57.5% | 64.2% | 74.1% | 61.5% | 63.6% | 39.7% |
| sonication) | | | | | | |
| IE3 (75° C., | 45.1% | 32.1% | 40.6% | 18.4% | 43.3% | 30.9% |
| sonication) | | | | | | |

### b) Comparison of Washing Efficiency of Different Concentrations of PEG/Water and Influence of NaOH

### Inventive Example 4 (IE4)

A mixture of 475 ml of polyethylene glycol and 25 ml of water (volume ratio PEG to water of 95/5) was added as the washing liquid to 50 g of cryo-milled rPO and the suspension was allowed to mix by means of an overhead stirrer for 2 hours at 75° C. The washing liquid was then removed by filtration and the polymer powder was two times rinsed with water. Each of these rinsing steps was done by contacting the polymer powder for 30 seconds with 100 ml of demineralised water, followed by removal of the water by filtration. The polymer powder was then dried in a vacuum oven at 70° C. for 1 hour.

### Inventive Example 5 (IE5)

As inventive example 4, except that instead of 25 ml of water 25 ml of a 5 wt-% aqueous NaOH solution was added to 475 ml of polyethylene glycol (volume ratio PEG to aqueous NaOH of 95/5) as wash liquid.

### Inventive Example 6 (IE6)

As inventive example 4, except that a mixture of 250 ml of polyethylene glycol and 250 ml of water (volume ratio PEG to water of 50/50) was added as the washing liquid.

### Inventive Example 7 (IE7)

As inventive example 6, except that instead of 250 ml of water 250 ml of a 5 wt-% aqueous NaOH solution was added to 250 ml of polyethylene glycol as wash liquid.

TABLE 6
Washing efficiency for a PEG/water wash and
PEG/NaOH wash - odour relevant substances

| | Acetic | Acetal- | Benzal- | | D- |
|---|---|---|---|---|---|
| Example | acid | dehyde | dehyde | Styrene | Limonene |
| IE4 (95% PEG) | 2.1% | 4.7% | 8.8% | 51.4% | 18.8% |
| IE5 (95% PEG, | 0.1% | 4.1% | 9.8% | 55.1% | 17.4% |
| 5% NaOH in H₂O) | | | | | |
| IE6 (50% PEG) | 5.7% | 4.1% | 9.9% | 52.7% | 41.2% |
| IE7 (50% PEG, | 0.1%* | 3.2% | 7.4% | 52.0% | 29.8% |
| 5% NaOH in H₂O) | | | | | |

TABLE 7
Washing efficiency for a PEG/water wash and
reference water wash - hazardous substances

| | | | Ethyl- | | |
|---|---|---|---|---|---|
| Example | Benzene | Toluene | benzene | o-Xylene | Styrene |
| IE4 (95% PEG) | 31.5% | 49.9% | 36.9% | 26.1% | 51.4% |
| IE5 (95% PEG, | 29.6% | 51.5% | 45.8% | 29.2% | 55.1% |
| 5% NaOH in H₂O) | | | | | |
| IE6 (50% PEG) | 41.5% | 56.8% | 36.7% | 33.2% | 52.7% |
| IE7 (50% PEG, | 38.1% | 52.3% | 37.3% | 28.7% | 52.0% |
| 5% NaOH in H₂O) | | | | | |

### c) Comparison of Washing Efficiency of Pure PEG, PEG/Water and the Influence of Different PEG Types and NaOH

In a second set of examples IE8-IE10 and CE4-CE6 a second batch of cryo-milled recycled polyolefin (rPO) has been washed with different washing liquids for evaluating the washing efficiency of pure water and mixtures of water and PEG in different weight amounts with and without addition of NaOH using the same washing conditions.

The PEG used in said second set of examples was PEG 200 and PEG 400 as indicated.

### Inventive Example 8 (IE8)*

A mixture of 250 ml of polyethylene glycol PEG 200 and 250 ml of water (volume ratio PEG 200 to water of 50/50) was added as the washing liquid to 50 g of cryo-milled rPO and the suspension was allowed to mix by means of an overhead stirrer for 2 hours at 75° C.

The washing liquid was then removed by filtration and the polymer powder was two times rinsed with water. Each of these rinsing steps was done by contacting the polymer powder for 30 seconds with 100 ml of demineralised water, followed by removal of the water by filtration. The polymer powder was then dried in a vacuum oven at 70° C. for 1 hour.

### Comparative Example 4 (CE4)*

As inventive example 8, except that instead of 250 ml of PEG 200 250 ml of PEG 400 was added to 250 ml of water was used as wash liquid.

CE4 qualifies as comparative as the pH of the washing liquid of PEG 400-H2O (50/50) has a pH below 7.0.

### Inventive Example 9 (IE9)*

As inventive example 8, except that instead of 250 ml of water 250 ml of a 5 wt-% aqueous NaOH solution was added to 250 ml of PEG 200 was used as wash liquid.

### Inventive Example 10 (IE10)*

As inventive example 9, except that instead of PEG 200 250 ml of PEG 400 was added to 250 ml of water was used as wash liquid.

### Comparative Example 5 (CE5)*

As inventive example 8, except that instead of 250 ml of PEG 200 and 250 ml of water (volume ratio PEG 200 to water of 50/50) 500 ml of PEG 200 without additional water (volume ratio PEG 200 to water of 100:0) was used as wash liquid.

### Comparative Example 6 (CE6)*

As inventive example 8, except that instead of 250 ml of PEG 200 and 250 ml of water (volume ratio PEG 200 to water of 50/50) 500 ml of PEG 400 without additional water (volume ratio PEG 400 to water of 100:0) was used as wash liquid.

TABLE 8
Washing efficiency of second set of
examples - odour relevant substances

| | Acetic | Acetal- | Benzal- | | D- |
|---|---|---|---|---|---|
| Example | acid | dehyde | dehyde | Styrene | Limonene |
| CE5 (100% PEG | 55% | 143% | 37% | 35% | n.d. |
| 200) | | | | | |
| CE6 (100% PEG | 84% | 348% | 121% | 30% | n.d. |
| 400) | | | | | |
| IE8 (50% PEG | 30% | 122% | 45% | 31% | n.d. |
| 200) | | | | | |
| CE4 (50% PEG | 19% | 101% | 55% | 29% | n.d. |
| 400) | | | | | |
| IE9 (50% PEG | n.d. | 156% | 23% | 32% | n.d. |
| 200 + NaOH) | | | | | |
| IE10 (50% PEG | n.d. | 100% | 23% | 30% | n.d. |
| 400 + NaOH) | | | | | |

n.d. = not detectable, below detection limit

TABLE 9
Washing efficiency second set of examples - hazardous substances

| | | | Ethyl- | o- | | Aceto- |
|---|---|---|---|---|---|---|
| Example | Benzene | Toluene | benzene | Xylene | Styrene | phenone |
| CE5 (100% | 34% | 41% | 42% | 41% | 35% | 37% |
| PEG 200) | | | | | | |
| CE6 (100% | 60% | 41% | 44% | 40% | 30% | 52% |
| PEG 400) | | | | | | |
| IE8 (50% | 27% | 40% | 42% | 44% | 31% | 43% |
| PEG 200) | | | | | | |
| CE4 (50% | 25% | 36% | 38% | 39% | 29% | 44% |
| PEG 400) | | | | | | |
| IE9 (50% | 23% | 38% | 39% | 31% | 32% | 43% |
| PEG 200 + | | | | | | |
| NaOH) | | | | | | |
| IE10 (50% | 22% | 37% | 38% | 32% | 30% | 40% |
| PEG 400 + | | | | | | |
| NaOH) | | | | | | |

When comparing the PEG-water mixtures to pure PEG (comparative examples CE5 and CE6) it can be seen from Tables 8 and 9 above that depending on the substance the PEG-water mixtures have a comparable or higher washing efficiency. Thereby, the PEG-water mixtures comprising NaOH (inventive examples IE9 and IE10) generally show the highest washing efficiency.

The washing liquid of comparative example CE4 has a pH of 6.5, which is outside the claimed range. The washing efficiency of CE4 is comparable to that of IE8 with the exception of benzaldehyde.

D-Limonene has not been detectable in any of the HS-GC/MS spectra after washing.

1. A process for reducing contaminants from polyolefin-containing particles, comprising the steps of:
a) providing particles comprising polyolefin and contaminants comprising volatile organic compounds and semi-volatile organic compounds;
b) contacting the particles with a washing liquid, which comprises a mixture of polyethylene glycol and water and has a pH in the range from 7.0 to 14.0;
c) removing the washing liquid from the particles,
thereby obtaining particles with a reduced amount of contaminants,
whereby volatile organic compounds are defined as organic compounds having an initial boiling point (b.p.) of less than or equal to 250° C. when measured at a standard atmospheric pressure of 101.3 kPa and semi-volatile organic compounds are defined as organic compounds having an initial boiling point (b.p.) of from 250 to 380° C. when measured at a standard atmospheric pressure of 101.3 kPa.

2. The process according to claim 1, wherein the particles comprise polyolefin in an amount of from 75.00 to 99.99 wt % based on the total weight of the particles.

3. The process according to claim 1, wherein the particles are powder, pellets or flakes.

4. The process according to claim 1, wherein the polyolefin is selected from virgin polyolefin and recycled polyolefin obtained from post-consumer waste and/or post-industrial waste.

5. The process according to claim 1, further comprising the step of a1) shredding polyolefin containing material to obtain particles comprising polyolefin and contaminants selected from volatile organic compounds and semi-volatile organic compounds prior to step a).

6. The process according to claim 1, wherein the ratio of polyethylene glycol to water in the washing liquid is in the range of from 25 vol. %: 75 vol. % to 99 vol. %: 1 vol.

7. The process according to claim 1, wherein the polyethylene glycol has an average molecular weight Mn of from 100 to 350 g/mol.

8. The process according to claim 1, wherein the washing liquid comprises a base selected from calcium hydroxide, potassium hydroxide, magnesium hydroxide, lithium hydroxide, sodium bicarbonate, sodium hydroxide and mixtures thereof, based on the total weight of the washing liquid.

9. The process according to claim 1, wherein the particles are contacted with the washing liquid in step b) at a temperature of from 20 to 100° C. for 5 to 240 min.

10. The process according to claim 1, wherein the particles and the washing liquid during step b) are subjected to agitation through mechanical mixing, ultrasonic treatment, mechanical grinding or pump around loop.

11. The process according to claim 1, further comprising the step of d) rinsing residue of the washing liquid and/or any other foreign material and/or degradation products thereof from the particles with an aqueous solution having a pH of from 7.0 to 14.0, which is carried out after step c).

12. The process according to claim 1, further comprising the step of e) drying the particles removed from the washing liquid in step c) and/or, if present, the particles removed from the aqueous solution in optional step d).

13. The process according to claim 1, wherein the particles obtained as a product of the process have:
a limonene content, as measured by HS-GC/MS, of less than 70% of the value measured before the process, and/or
an acetic acid content, as measured by HS-GC/MS, of less than 15% of the value measured before the process, and/or
an acetaldehyde content, as measured by HS-GC/MS, of less than 25% of the value measured before the process, and/or
a benzaldehyde content, as measured by HS-GC/MS, of less than 25% of the value measured before the process.

14. The process according to claim 1, wherein the particles obtained as a product of the process have:
a benzene content, as measured by HS-GC/MS, of less than 150% of the value measured before the process, and/or
a toluene content, as measured by HS-GC/MS, of less than 75% of the value measured before the process, and/or
an ethyl benzene content, as measured by HS-GC/MS, of less than 70% of the value measured before the process, and/or
an o-xylene content, as measured by HS-GC/MS, of less than 70% of the value measured before the process, and/or
a styrene content, as measured by HS-GC/MS, of less than 70% of the value measured before the process.

15. A method of removing contaminants comprising volatile organic compounds and semi-volatile organic compounds from particles comprising polyolefin and contaminants comprising volatile organic compounds and semi-volatile organic compounds the method comprising: providing a washing liquid, which comprises a mixture of polyethylene glycol and water and has a pH in the range from 7.0 to 14.0,
whereby volatile organic compounds are defined as organic compounds having an initial boiling point (b.p.) of less than or equal to 250° C. when measured at a standard atmospheric pressure of 101.3 kPa and semi-volatile organic compounds are defined as organic compounds having an initial boiling point (b.p.) of from 250 to 380° C. when measured at a standard atmospheric pressure of 101.3 kPa.
